(19) United States
(12) Patent Application Publication
(10) Pub. No.: US 2006/0197376 A1
(43) Pub. Date: Sep. 7, 2006

(54) Hybrid air brake actuation

(75) Inventor: Robert J. Herbst, Avon, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC

(21) Appl. No.: 11/070,749

(22) Filed: Mar. 2, 2005

(51) Int. Cl. B60T 13/00

(52) U.S. Cl. 303/127

(57) ABSTRACT

The present application relates to a hybrid air brake actuation. One hybrid air brake actuating system for controlling communication of pressurized air from an air supply to a vehicle brake includes a hydraulic control component and a hydraulic to pneumatic actuating arrangement. The hydraulic control component provides brake control signals through hydraulic fluid based on a force applied to a brake control, such as a brake pedal. The hydraulic to pneumatic actuating arrangement controls communication of pressurized air from the air supply to the vehicle brake based on the brake control signals.

### FIELD OF THE INVENTION

The present disclosure relates generally to vehicle air brakes, and more particularly, hybrid air brake actuation.

### BACKGROUND OF THE INVENTION

Air brake systems are commonly used for stopping vehicles. One example of an existing vehicle air brake system includes an air pressure supply, a brake valve coupled to a brake pedal, pneumatic relay valves, and brake actuators. Air lines between the air pressure supply and the brake valve provide pressurized air to the brake valve. Air lines between the air pressure supply and the relay valves provide pressurized air to the relay valves. Air lines between the relay valves and the brake actuators selectively provide pressurized air to the brake actuators. Air lines between the brake valve and the and the relay valves provide pressurized air from the brake valve to the relay valves based on the force applied to the brake pedal. The relay valves apply pressure to the brake actuators based on the force applied to the brake valve to selectively apply the brakes based on the force applied to of the brake pedal.

In some vehicles, the air supply is located at or near the rear of the vehicle and the brake valve is located at a position near the front of the vehicle. An air line from the air supply to the brake valve extends from the rear of the vehicle to the position near the front of the vehicle. Similarly, an air line for controlling the rear brakes extends back from the air valve near the front of the vehicle back to the rear of the vehicle.

### SUMMARY

The present application relates to a hybrid air brake actuation. One hybrid air brake actuating system for controlling communication of pressurized air from an air supply to a vehicle brake includes a hydraulic control component and a hydraulic to pneumatic actuating arrangement. The hydraulic control component provides brake control signals through hydraulic fluid based on the force applied to a brake control, such as a brake pedal. The hydraulic to pneumatic actuating arrangement controls communication of pressurized air from the air supply to the vehicle brake based on the brake control signals.

The hydraulic to pneumatic actuating arrangement may take a wide variety of different forms. One example of a hydraulic to pneumatic actuating arrangement is a hydraulic to pneumatic brake relay valve. One example of a hydraulic to pneumatic brake relay valve includes a relay valve body and a brake air regulating mechanism. The relay valve body includes a hydraulic fluid inlet port, a pressurized air inlet port and a brake air outlet port. In one embodiment, the relay valve body includes an air exhaust port. The brake air regulating mechanism is disposed in the valve body. The brake air regulating mechanism controls a flow of pressurized air from the air inlet port to the air outlet port based on hydraulic pressure applied in the hydraulic fluid inlet port. Another example of a hydraulic to pneumatic actuating arrangement comprises a hydraulic actuator assembled with a pneumatic brake valve such that the pneumatic brake valve is actuated by the hydraulic actuator.

The hydraulic control component may take a wide variety of different forms. For example, the hydraulic control component may be a hydraulic master cylinder, such as a dual hydraulic master cylinder.

In one embodiment, the hydraulic to pneumatic actuating arrangement is positioned on the vehicle such that pneumatic lines from the hydraulic to pneumatic actuating arrangement to the brake actuators are substantially the same length. For example, the difference in length between the pneumatic lines may be less than five feet. The hydraulic to pneumatic actuating arrangement is positioned such that all air lines that communicate air under pressure to vehicle drive wheels are positioned outside a vehicle engine compartment. In one embodiment, all air lines are positioned outside the vehicle engine compartment. In this embodiment, hydraulic lines may run through the engine compartment. In one embodiment, the hydraulic to pneumatic actuating arrangement is mounted to an air supply reservoir.

In one embodiment, a first hydraulic to pneumatic actuating arrangement applies air pressure to brakes of a front axle and a second hydraulic to pneumatic actuating arrangement applies air pressure to brakes of a rear axle. A first hydraulic fluid flow path is defined between the hydraulic control component and the first hydraulic to pneumatic actuating arrangement. A second hydraulic fluid flow path is defined between the hydraulic control component and the second hydraulic to pneumatic actuating arrangement. In one embodiment, a hydraulic to pneumatic actuating arrangement controls application of brakes of a trailer.

According to one method of controlling communication of pressurized air from an air supply to a vehicle brake, brake control signals are provided through hydraulic fluid based on the force applied to a brake control such as a brake pedal. Communication of pressurized air from the air supply to the vehicle brake is controlled based on the brake control signals. In one embodiment, communication of air to trailer brakes is controlled based on the brake control signals.

Further advantages and benefits will become apparent to those skilled in the art after considering the following description and appended claims in conjunction with the accompanying drawings.

### BRIEF DESCRIPTION OF THE DRAWINGS

FIG. 1 is a schematic illustration of a hybrid air brake actuating system;

FIG. 2 is a schematic illustration of a hydraulic to pneumatic actuating arrangement;

FIG. 3 A is a sectional view of a hydraulic to pneumatic brake relay valve;

FIG. 3 B is a sectional view of a hydraulic to pneumatic brake relay valve;

FIG. 3 C is a sectional view of a hydraulic to pneumatic brake relay valve;

FIG. 4 is a schematic illustration of a hydraulic to pneumatic actuation arrangement;

FIG. 4A is a schematic illustration of a hydraulic to pneumatic actuation arrangement;

FIG. 5 is schematic illustration of a vehicle brake system that includes a hybrid air brake actuating system;

FIG. 6 is schematic illustration of a vehicle brake system that includes a hybrid air brake actuating system;

FIG. 7 is schematic illustration of a vehicle brake system that includes a hybrid air brake actuating system;

FIG. 8 is schematic illustration of a vehicle brake system that includes a hybrid air brake actuating system; and

FIG. 9 is schematic illustration of a hybrid air brake actuating system positioned on a vehicle.

### DETAILED DESCRIPTION

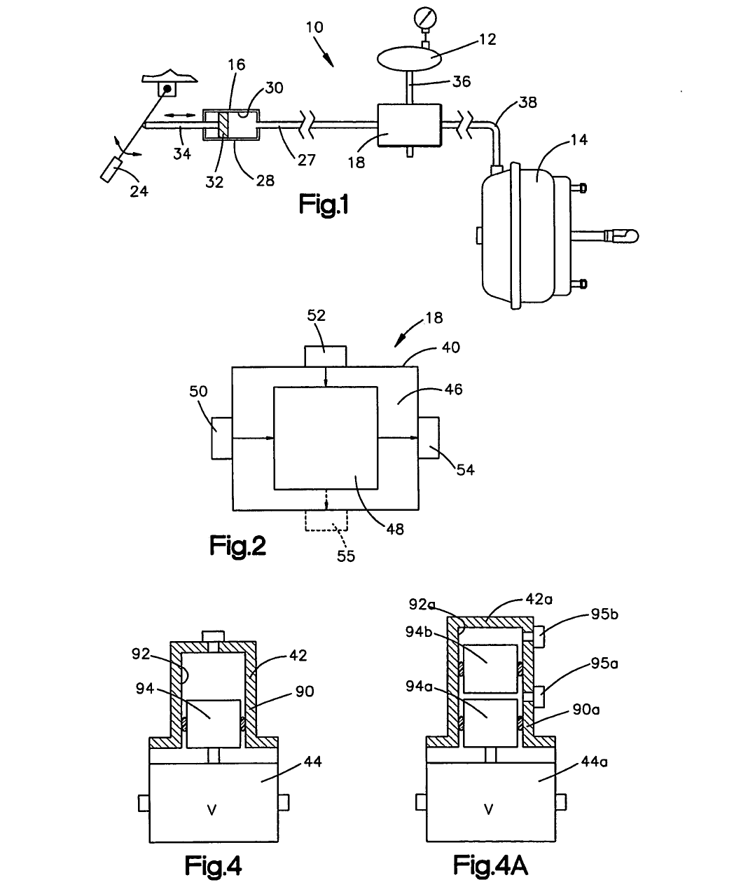

The present disclosure is directed to hybrid air brake actuation. One example of a hybrid air brake actuating system 10 is illustrated by FIG. 1. In the example illustrated by FIG. 1, the hybrid air brake actuating system 10 controls communication of pressurized air from an air supply 12 to a vehicle brake actuator 14. The illustrated hybrid air brake actuating system 10 includes a hydraulic control component 16 and a hydraulic to pneumatic actuating arrangement 18. The hydraulic control component 16 provides brake control signals through hydraulic fluid to the hydraulic to pneumatic actuating arrangement 18 based on a position of a brake control, such as the illustrated brake pedal 24. The hydraulic to pneumatic actuating arrangement 18 controls communication of pressurized air from the air supply 12 to the vehicle brake actuator 14 based on the hydraulic brake control signals.

In the example illustrated by FIG. 1, the hydraulic control component 16 is coupled to the hydraulic to pneumatic actuating arrangement 18 by a hydraulic line 27. The illustrated hydraulic control component includes a housing 28 that defines a cylinder 30. A piston 32 is disposed in the cylinder 30. The cylinder 30 and the hydraulic line 27 are filled with hydraulic fluid. A piston actuator 34 extends from the piston 32 out of the housing 28. The actuator 34 is coupled to the brake pedal 24 such that pressing on the brake pedal moves the piston 32 in the cylinder 30. The piston 28 forces hydraulic fluid in the line 27 toward the to the hydraulic to pneumatic actuating arrangement 18 when the brake pedal is depressed. Examples of a suitable hydraulic control components 16 include the wide variety of master cylinders that are available for automotive hydraulic brakes. The hydraulic control component 16 can be positioned at a wide variety of vehicle locations. The hydraulic control component can be located at any location that is accessible to the operator directly or by a linkage, including but not limited to in the engine compartment, to the firewall, outside the cab, and inside the cab.

In one embodiment, the hydraulic control component 16 is replaced with another control component, such as a wired electronic control component, a wireless electronic control component, or a mechanical link. In this embodiment, the hydraulic to pneumatic actuating arrangement 18 is replaced with an actuating arrangement that controls communication of pressurized air 26 from the air supply 12 to the vehicle brake actuator 14 based on the control signals or movements from the control component.

Referring to the example illustrated by FIG. 1, the supply 12 provides pressurized air to the hydraulic to pneumatic actuating arrangement 18 through a line 36. The hydraulic to pneumatic actuating arrangement 18 communicates the air from the supply 12 to the brake actuator 14 through a line 38 based on the pressure of the hydraulic fluid applied to the hydraulic to pneumatic actuating arrangement. In the exemplary embodiment, the pressure of the air provided from the air supply 12 by the hydraulic to pneumatic actuating arrangement 18 to the brake actuator 14 is proportional to the pressure of the hydraulic fluid provided to the hydraulic to pneumatic actuating arrangement. For example, aggressively pressing the brake pedal results in relatively high pressure in the hydraulic fluid. The relatively high pressure in the hydraulic fluid causes air under a relatively high pressure to be provided to the brake actuator 14, which causes relatively aggressive application of the brakes. Gently pressing the brake pedal results in relatively low pressure in the hydraulic fluid. The relatively low pressure in the hydraulic fluid causes air under a relatively low pressure to be provided to the brake actuator 14, which causes relatively light application of the brakes.

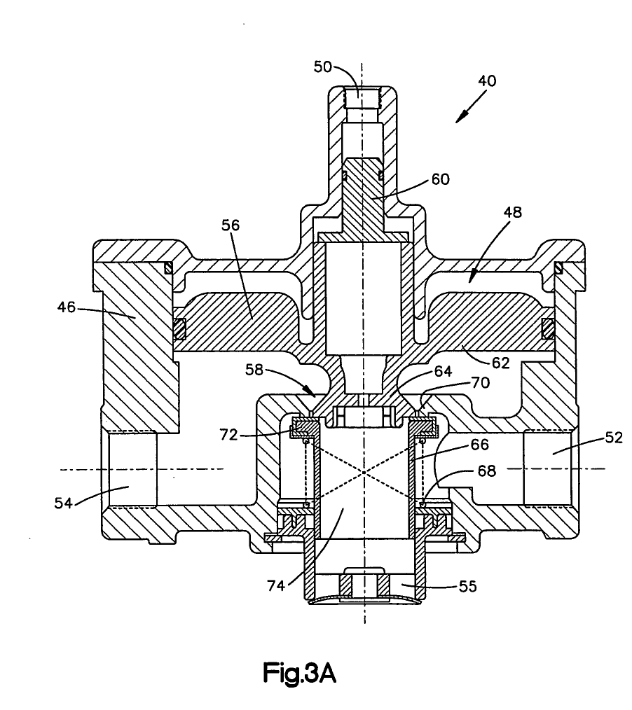

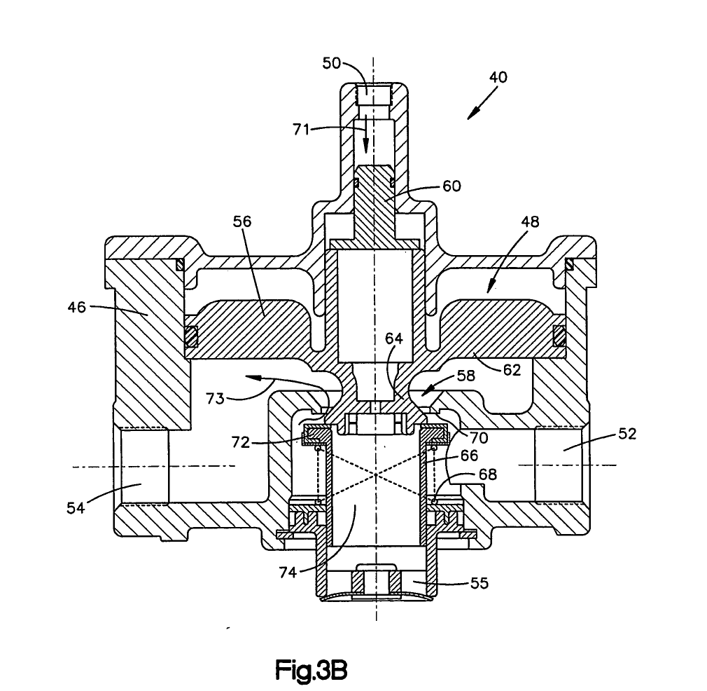

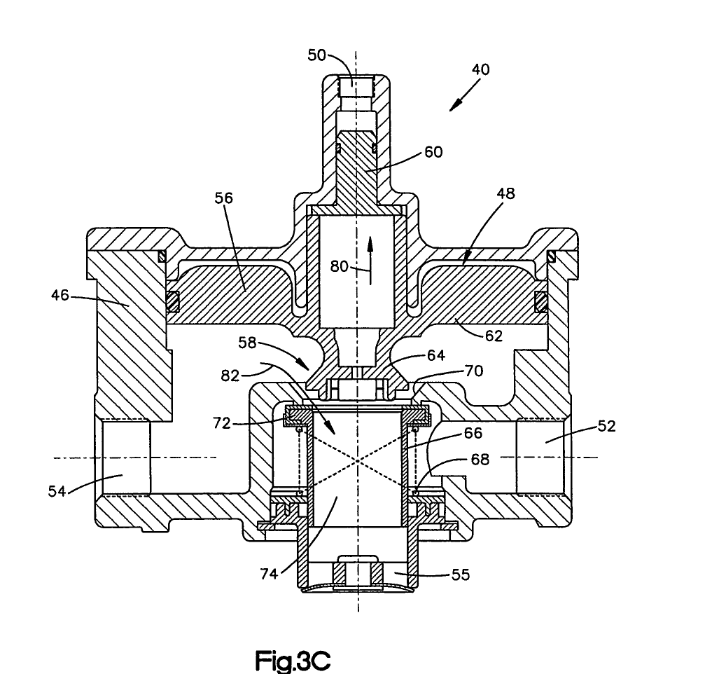

The hydraulic to pneumatic actuating arrangement 18 may take a wide variety of different forms. Two examples of hydraulic to pneumatic actuating arrangements are a hydraulic to pneumatic brake relay valve 40 (FIGS. 2, 3A, 3B, 3C) and a hydraulic actuator 42 assembled with a pneumatic brake valve 44 (FIG. 4) such that the pneumatic brake valve is actuated by the hydraulic actuator.

FIG. 2 schematically illustrates a hydraulic to pneumatic brake relay valve 40. In the example of FIG. 2, the pneumatic to hydraulic brake relay valve includes a relay valve body 46 and a brake air regulating mechanism 48. The relay valve body 46 includes a hydraulic fluid inlet port 50, a pressurized air inlet port 52, a brake air outlet port 54, and a vent port 55. The brake air regulating mechanism 48 is disposed in the valve body. The brake air regulating mechanism 48 controls the flow of pressurized air from the inlet port 52 to the brake air outlet port 54 based on hydraulic pressure applied in the hydraulic fluid inlet port 50.

FIGS. 3A-3C are sectional views of one example of a hydraulic to pneumatic brake relay valve 40. In the example illustrated by FIGS. 3A-3C, the brake air regulating mechanism 48 comprises a piston 56 and a valve assembly 58. The piston 56 is disposed in the relay valve body 46 such that hydraulic fluid provided to the inlet port 50 acts on a hydraulically driven portion 60 and pressurized air at the outlet port 54 acts on a pneumatically driven portion 62. In the example of FIGS. 3A-3C, the surface area of the hydraulically driven portion 60 that is acted on by the hydraulic fluid is less than the surface area of the pneumatically driven portion 62 that is acted on by pressurized air. A much larger force can be applied through hydraulic fluid than through air. As a result, the hydraulically driven portion can be significantly smaller than the pneumatically driven portion.

The valve assembly 58 includes a vent blocking member 64, a supply blocking member 66, a biasing member 68, and a valve seat 70 defined by the valve body. The supply blocking member 66 is a tubular member with an annular shoulder 72. A passage 74 through the tubular member 66 is in communication with the vent port 55. In the example illustrated by FIGS. 3A-3C, the biasing member 68 is a spring disposed around the supply blocking member 66. The biasing member 68 engages the annular shoulder 72 to bias the supply blocking member 66 into engagement with the valve seat 70. When the supply blocking member 66 engages the valve seat 70, air flow is inhibited between the air inlet port 52 and the outlet port 54. When the supply blocking member 66 is spaced apart from the valve seat 70, air flows between the air inlet port 52 and the outlet port 54. The vent blocking member 64 extends from the piston 56. The piston 56 moves the vent blocking member 64 into and out of engagement with the supply blocking member 66. When the vent blocking member 64 is in engagement with the supply blocking member 66, the vent blocking member blocks the passage through the supply blocking member to inhibit air flow from the outlet port out of the vent port 55. When the vent blocking member 64 is spaced apart from the supply blocking member 66, the vent blocking allows air flow through the supply blocking member passage to allow air to flow from the outlet port 54 to the vent port.

FIGS. 3A-3C illustrate operation of the hydraulic to pneumatic brake relay valve. FIG. 3A illustrates the position of the valve assembly components when the relay valve is in a state of equilibrium. That is, the force applied to the piston 56 by the air in the valve body is equal to the force applied to the piston by the hydraulic fluid. In the state illustrated by FIG. 3A, the airflow from the air inlet port 52 to the air outlet port 54 is blocked and airflow from the outlet port 54 to the vent port 55 is blocked.

FIG. 3B illustrates the hydraulic to pneumatic brake relay valve 40 in an open state. The open state occurs when the brake pedal 24 is initially pressed to apply pressure to the hydraulic fluid at the hydraulic inlet port 50. The hydraulic fluid forces the piston 56 in the direction indicated by arrow 71 against the force applied by air in the housing and the biasing force of the spring. The vent blocking member 64 engages and moves the supply blocking member 66 away from the valve seat 70 to allow flow from the air inlet port 52 to the air outlet port 54 as indicated by arrow 73. The flow of air from the inlet port 52 to the outlet port 54 continues until the force applied to the piston by the air in the housing and the spring reaches or slightly exceeds the force applied to the piston by the hydraulic fluid. When the force applied to the piston by the air and the spring reaches or slightly exceeds the force applied to the piston by the hydraulic fluid, the piston returns to the equilibrium position illustrated by FIG. 3A. If the brake pedal is further depressed, the valve will open again to apply more air pressure to the brake chamber 14 and then return to the equilibrium position. As such, the pressure of the air provided to the brake chambers by the hydraulic to pneumatic brake relay valve 40 is proportional to the force applied to the brake pedal 24.

FIG. 3C illustrates the hydraulic to pneumatic brake relay valve 40 in a vent state. The vent state occurs when the brake pedal 24 is released to remove hydraulic pressure at the hydraulic inlet port 50. The air in the housing forces the piston 56 in the direction indicated by arrow 80 against the force applied by hydraulic fluid. The vent blocking member 64 moves away from the inlet blocking member 66 to allow flow from the air outlet port 54 to the vent port 55 as indicated by arrow 82. The inlet blocking member 66 is pressed against the value seat 70 to inhibit flow between the air inlet and the air outlet. The flow of air from the outlet port 54 to the vent port 55 continues until the force applied to the piston by the air in the housing equalizes with the force applied to the piston by the hydraulic fluid. When the forces equalize, the piston returns to the equilibrium position illustrated by FIG. 3A.

In the embodiment illustrated by FIG. 4, the hydraulic to pneumatic actuating arrangement comprises a hydraulic actuator 42 assembled with a separate pneumatic brake valve 44. The hydraulic actuator 42 illuistrated by FIG. 4 includes a housing 90 that defines a cylinder 92 and a piston 94 disposed in the cylinder. Hydraulic fluid under pressure is provided into the cylinder to move the piston 94. For example, the hydraulic fluid may be provided by a master cylinder. The hydraulic actuator 42 is assembled with the valve, such that the piston 94 controls the valve actuator. In one embodiment, traditional pneumatic relay valves are provided with control air from the brake valve of the hydraulic actuator and brake valve arrangement to control the pressurized air that is provided to the brake actuators. Examples of acceptable brake valves that may be used in accordance with this embodiment include Bendix dual circuit brake valve model numbers E-6, E-7, E-8P, E-10P, E-10PR, E-12, E-14, and E-15A.

FIG. 4A illustrates a dual piston hydraulic actuator 42a assembled with a separate pneumatic brake valve 44. The hydraulic actuator 42a illuistrated by FIG. 4A includes a housing 90a that defines a cylinder 92a and first and second pistons 94a, 94b disposed in the cylinder. Hydraulic fluid under pressure is provided into the cylinder though ports 95a, 95b from two hydraulic fluid outlet ports of a dual master cylinder to move the pistons 94a, 94b. The hydraulic actuator 42a is assembled with the brake valve 44 valve, such that the pistons 94a, 94b control the brake valve.

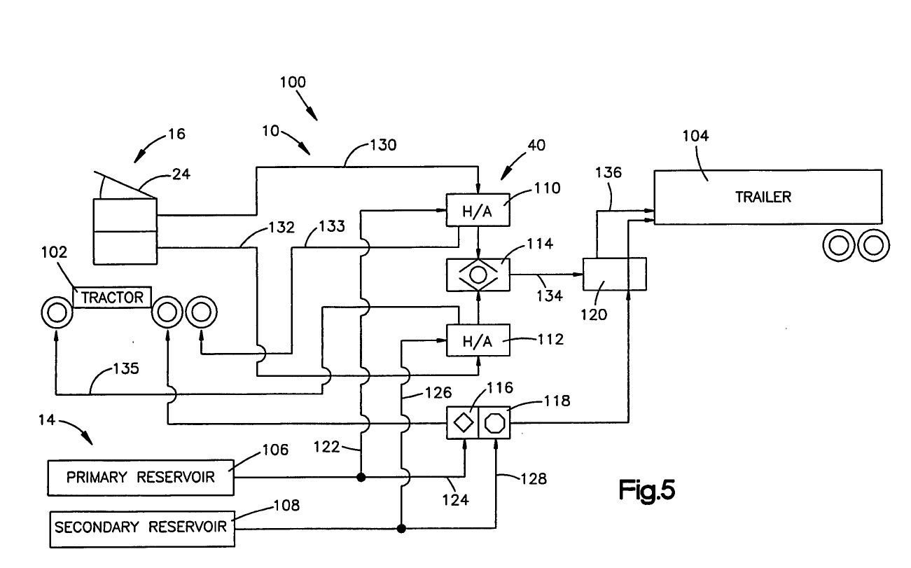

The disclosed hybrid air brake actuating system 10 can be used to actuate air brakes of a wide variety of different vehicles that include air brakes. For example, the hybrid air brake actuating system can be used on vehicles such as, but not limited to tractors, trailers, busses, trucks, rear engine vehicles, such as coaches and construction vehicles, such as cement mixers, and any other automotive vehicle that includes air brakes. FIG. 5 is a schematic illustration of an exemplary hybrid air brake actuating system 10 applied to an air brake system 100 of a tractor 102 and trailer 104. The air brake system includes a primary air reservoir 106, a secondary air reservoir 108, a hydraulic control component 16, a primary hydraulic to pneumatic brake relay valve 110, a secondary hydraulic to pneumatic brake relay valve 112, a check valve 114, a system parking brake control valve 116, a trailer air supply control valve 118, and a tractor protection valve 120. The primary reservoir 106 supplies pressurized air to the primary hydraulic to pneumatic brake relay valve 110 and the tractor park control valve 116 through air lines 122, 124. The secondary reservoir supplies pressurized air to the secondary hydraulic to pneumatic brake relay valve 112 and the trailer air supply control valve 118 through air lines 126, 128. The hydraulic control component 16 provides hydraulic control signals to the primary and secondary hydraulic to pneumatic brake relay valves through hydraulic lines 130, 132. In the exemplary embodiment, the hydraulic control lines have a smaller diameter than the air lines. For example, the hydraulic control lines may have a diameter of approximately 0.250″ and the air lines may have a diameter of approximately 0.500″. The primary hydraulic to pneumatic relay valve 110 applies pressurized air over line 133 to rear brakes of the tractor and to the double check valve 114 based on the hydraulic signals from the hydraulic control component 16. The secondary hydraulic to pneumatic relay valve 112 applies pressurized air over line 135 to front brakes of the tractor and to the double check valve 114 based on the hydraulic signals from the hydraulic control component 16. The pressurized air provided to the check valve is communicated to trailer brakes over a line 134 from the double check valve to the tractor protection valve 120 and over a line 136 from the tractor protection valve to the trailer. The parking brake control valve 116 is operated by the driver to apply and release the parking brakes. The trailer air supply control valve 118 is operated by the driver to apply and release the trailer parking brakes and “supply air” to the trailer air reservoirs. When the driver presses the brake pedal 24, the hydraulic control component 16 forces hydraulic fluid to the primary and secondary relay valves 110, 112. The force of the hydraulic fluid causes the primary and secondary relay valves 110, 112 to open and communicate air from the primary and secondary reservoirs to actuate the tractor and trailer brakes. When the driver's foot is removed from the brake pedal, the hydraulic control component removes the hydraulic force applied to the primary and secondary relay valves 110, 112. The primary and secondary hydraulic to pneumatic relay valves vent the air pressure applied to the brake actuators and the tractor and trailer brakes disengage.

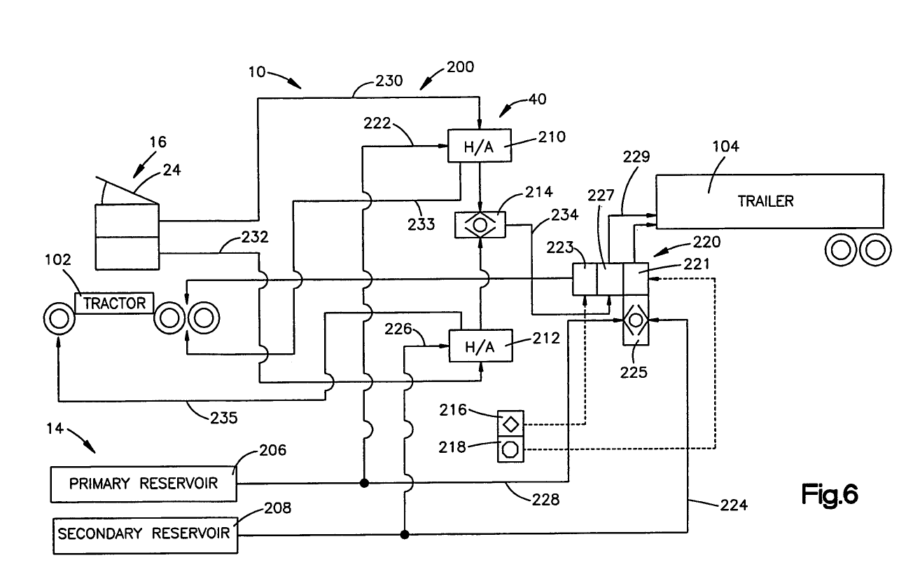

FIG. 6 is a schematic illustration of another example of a hybrid air brake actuating system 10 applied to an air brake system 200 of a tractor 102 and trailer 104. The air brake system includes a primary air reservoir 206, a secondary air reservoir 208, a hydraulic control component 16, a primary hydraulic to pneumatic brake relay valve 210, a secondary hydraulic to pneumatic brake relay valve 212, a check valve 214, a tractor parking brake control switch 216, a trailer air supply control switch 218, and a tractor protection module 220. The tractor protection module 220 includes an electrically actuated trailer air supply switch 221, an electrically actuated system parking brake switch 223, a reservoir double check valve 225, and a tractor protection valve 227. The primary reservoir 206 supplies pressurized air to the primary hydraulic to pneumatic brake relay valve 210 and the tractor protection module 220 through air lines 222, 228. The secondary reservoir supplies pressurized air to the secondary hydraulic to pneumatic brake relay valve 212 and the tractor protection module 220 through air lines 226, 224. The hydraulic control component 16 provides hydraulic control signals to the primary and secondary hydraulic to pneumatic brake relay valves through hydraulic lines 230, 232. The primary hydraulic to pneumatic relay valve 210 applies pressurized air over line 233 to rear brakes of the tractor and to the double check valve 214 based on the hydraulic signals from the hydraulic control component 16. The secondary hydraulic to pneumatic relay valve 212 applies pressurized air over line 235 to front brakes of the tractor and to the double check valve 214 based on the hydraulic signals from the hydraulic control component 16. The pressurized air provided to the check valve is communicated to trailer brakes over a line 234 from the double check valve to the tractor protection module 220 and over a line 229 from the tractor protection module to the trailer. The tractor parking brake control switch 216 controls the tractor parking brake valve 223 to selectively apply the tractor parking brakes. The trailer parking brake control switch 218 controls the trailer parking brake valve 221 to selectively apply the trailer parking brakes. When the driver presses the brake pedal 24, the hydraulic control component 16 forces hydraulic fluid to the primary and secondary relay valves 210, 212. The force of the hydraulic fluid causes the primary and secondary relay valves 210, 212 to open and communicate air from the primary and secondary reservoirs to actuate the tractor and trailer brakes. When the driver's foot is removed from the brake pedal, the hydraulic control component removes the hydraulic force applied to the primary and secondary relay valves 210, 212. The primary and secondary hydraulic to pneumatic relay valves vent the air pressure applied to the brake actuators and the tractor and trailer brakes disengage.

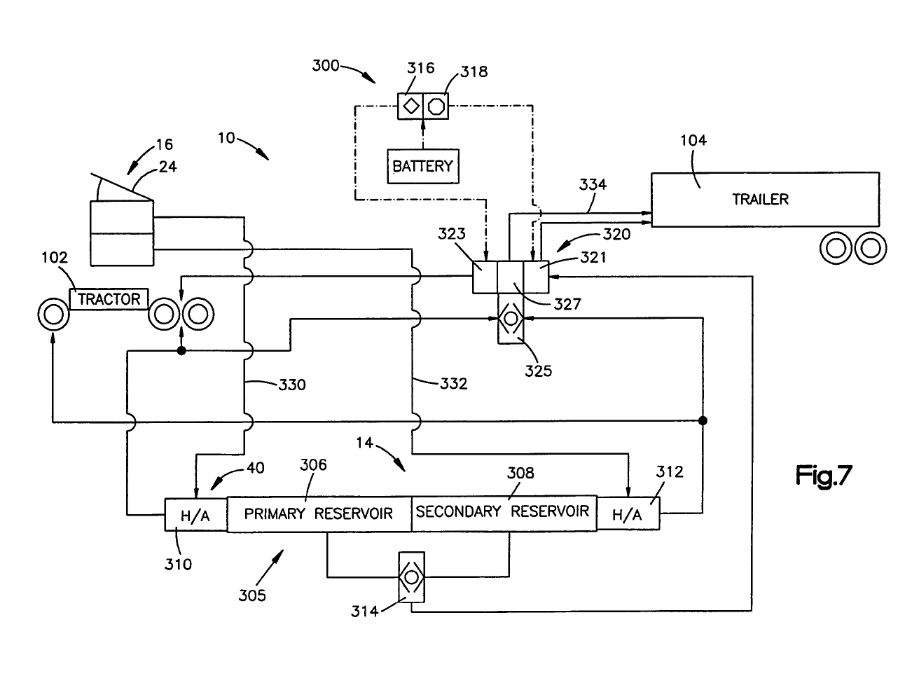

FIG. 7 is a schematic illustration of another example of a hybrid air brake actuating system 10 applied to an air brake system 300 of a tractor 102 and trailer 104. The air brake system includes a reservoir and relay module 305, a hydraulic control component 16, a check valve 314, a system parking brake control switch 316, a trailer air supply control switch 318, and a tractor protection module 320. The reservoir and relay module 305 includes a primary air reservoir 306, a secondary air reservoir 308, a primary hydraulic to pneumatic brake relay valve 310, and a secondary hydraulic to pneumatic brake relay valve 312. The primary relay valve 310 is mounted directly to the primary reservoir 306 such that the primary relay valve is in fluid communication with the primary reservoir. The secondary relay valve 312 is mounted directly to the secondary reservoir 308 such that the secondary relay valve is in fluid communication with the secondary reservoir. The tractor protection module 320 includes an electrically actuated trailer air supply switch 321, an electrically actuated system parking brake switch 323, a double check valve 325, and a tractor protection valve 327. The primary reservoir 306 supplies pressurized air to the primary hydraulic to pneumatic brake relay valve 310 and the tractor protection module 320 via the check valve 314. The secondary reservoir supplies pressurized air to the secondary hydraulic to pneumatic brake relay valve 312 and to the tractor protection module 320 via the check valve 314. The hydraulic control component 16 provides hydraulic control signals to the primary and secondary hydraulic to pneumatic brake relay valves through hydraulic lines 330, 332. The primary hydraulic to pneumatic relay valve 310 applies pressurized air to rear brakes of the tractor and to the tractor protection valve 327 via the double check valve 325 based on the hydraulic signals from the hydraulic control component 16. The secondary hydraulic to pneumatic relay valve 312 applies pressurized air to front brakes of the tractor and to the tractor protection valve via the double check valve 327 based on the hydraulic signals from the hydraulic control component 16. The pressurized air provided to the check valve 327 is communicated to trailer brakes over a line 334 from the tractor protection module 320 to the trailer. The parking brake control switch 316 controls the parking brake valve 323 to selectively apply the system parking brakes. The trailer air supply control switch 318 controls the trailer air supply valve 321 to selectively apply the trailer parking brakes.

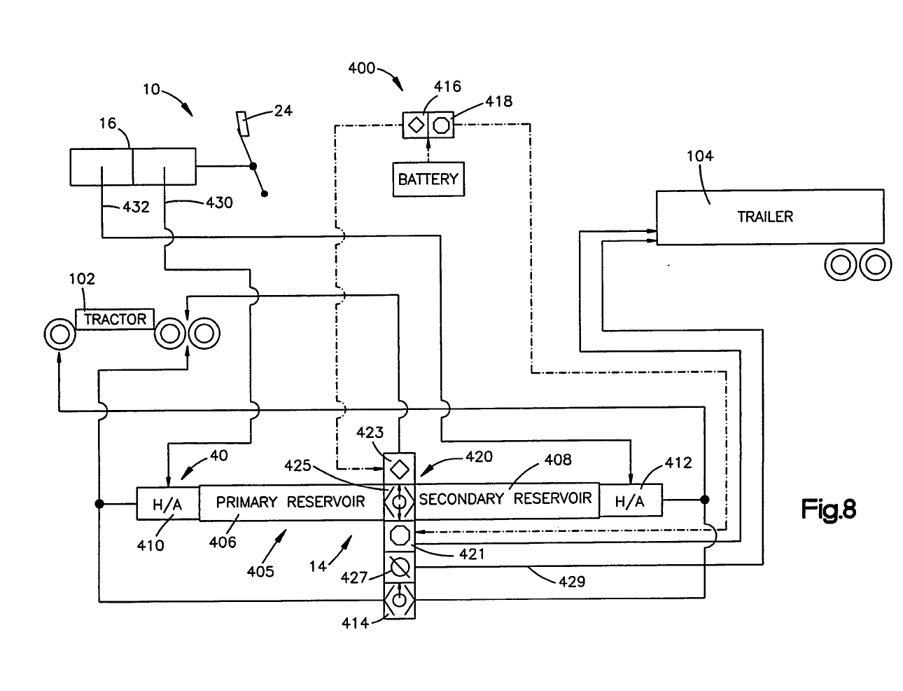

FIG. 8 is a schematic illustration of another example of a hybrid air brake actuating system 10 applied to an air brake system 400 of a tractor 102 and trailer 104. The air brake system includes a reservoir and relay module 405, a hydraulic control component 16, a system parking brake control switch 416, a trailer air supply control switch 418, and a tractor protection module 420. The reservoir and relay module 405 includes a primary air reservoir 406, a secondary air reservoir 408, a primary hydraulic to pneumatic brake relay valve 410, and a secondary hydraulic to pneumatic brake relay valve 412. The primary relay valve 410 is mounted directly to the primary reservoir 406 such that the primary relay valve is in fluid communication with the primary reservoir. The secondary relay valve 412 is mounted directly to the secondary reservoir 408 such that the secondary relay valve is in fluid communication with the secondary reservoir. The tractor protection module 420 includes an electrically actuated trailer air supply valve 421, an electrically actuated tractor parking brake valve 423, a reservoir double check valve 425, a tractor protection valve 427, and a relay check valve 414. In the example illustrated by FIG. 8, the tractor protection module 420 is mounted directly to the primary and secondary reservoirs such that the reservoir double check valve 425 is in fluid communication with both the primary reservoir and the secondary reservoir. The primary reservoir 406 supplies pressurized air to the primary hydraulic to pneumatic brake relay valve 410 and to the tractor protection module 420 via the check valve 425. The secondary reservoir supplies pressurized air to the secondary hydraulic to pneumatic brake relay valve 412 and the tractor protection module 420 via the check valve 425. The hydraulic control component 16 provides hydraulic control signals to the primary and secondary hydraulic to pneumatic brake relay valves through hydraulic lines 430, 432. The primary hydraulic to pneumatic relay valve 410 applies pressurized air to rear brakes of the tractor and to the double check valve 414 based on the hydraulic signals from the hydraulic control component 16. The secondary hydraulic to pneumatic relay valve 412 applies pressurized air to front brakes of the tractor and to the double check valve 414 based on the hydraulic signals from the hydraulic control component 16. The pressurized air provided to the check valve 414 is communicated to trailer brakes over a line 429 from the tractor protection module to the trailer. The system parking brake control switch 416 controls the tractor parking brake and trailer air supply valves to selectively apply the system parking brakes. The trailer air supply control switch 418 controls the trailer air supply valve 421 to selectively apply the trailer parking brakes.

In the examples illustrated by FIGS. 5-8, the hydraulic to pneumatic relay valves can be positioned such that the pneumatic lines from the hydraulic to pneumatic relay valves to the brake actuators are substantially the same length. For example, a difference in length between the longest pneumatic actuator line and the shortest pneumatic actuator line is less than five feet. Keeping the pneumatic lines approximately the same length provides balance between each of the vehicle brakes. In the exemplary embodiment, the distance from the air reservoirs to the hydraulic to pneumatic relay valves is minimized. In the examples illustrated by FIGS. 7 and 8, lines from the reservoirs to the hydraulic to pneumatic actuators are eliminated altogether. Minimizing the length of the pneumatic lines results in fast response times of the brakes. Use of the hydraulic lines also improves the response of the brake system.

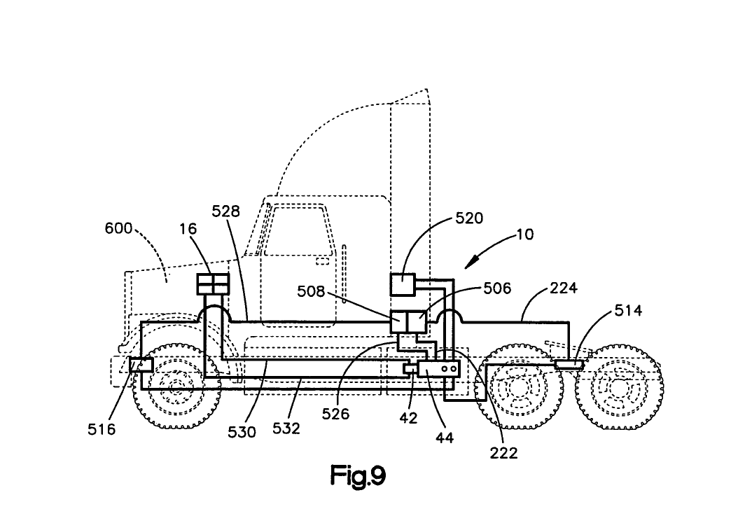

FIG. 9 illustrates an example of a hybrid air brake actuating system 10 where the hydraulic to pneumatic actuating arrangement comprises a hydraulic actuator 42 assembled with a separate pneumatic brake valve 44. The brake actuating system illustrated by FIG. 9 includes a primary air reservoir 506, and a secondary air reservoir 508. The hydraulic control component 16 is a dual circuit master cylinder. The hydraulic actuator 42 is a dual circuit hydraulic actuator and the brake valve 44 is a dual circuit air brake valve. The illustrated system also includes a primary pneumatic to pneumatic relay valve 514, a secondary pneumatic to pneumatic relay valve 516, and a tractor protection valve 520. The primary reservoir 506 supplies pressurized air to the dual circuit air brake valve 44 and the primary relay valve 514 through air lines 222, 224. The secondary reservoir supplies pressurized air dual circuit air brake valve 44 and to the secondary brake relay valve 516 through air lines 526, 528. The dual circuit master cylinder 16 provides hydraulic control signals to the dual circuit hydraulic actuator 42 through hydraulic lines 530, 532. The dual circuit hydraulic actuator 42 controls the dual circuit air brake valve 44 based on the force applied to the brake pedal. The primary pneumatic to pneumatic relay valve 514 applies pressurized air to rear brakes of the tractor based on the based on the position of the air brake valve 44. The secondary pneumatic to pneumatic relay valve 516 applies pressurized air to front brakes of the tractor based on the based on the force applied to the air brake valve 44. The air brake valve also provides pressurized air to the tractor protection valve 520 based on the force applied to the brake pedal. Park braking may be provided in the manners described with respect to FIGS. 5-8 and by similar manners. When the driver presses the brake pedal 24, the hydraulic control component dual circuit master cylinder 16 forces hydraulic fluid to the dual circuit hydraulic actuator 42. The dual circuit hydraulic actuator 42 opens the dual circuit brake valve 44 to provide pressurized air to the primary and secondary pneumatic relay valves 514, 516. The force of the pressurized air causes the primary and secondary relay valves 514, 516 to open and communicate air from the primary and secondary reservoirs to actuate the tractor and trailer brakes. When the driver's foot is removed from the brake pedal, the hydraulic control component removes the hydraulic force applied to the hydraulic actuator. The brake valve vents the applied pressurized air to the primary and secondary relay valves 514, 516. The primary and secondary pneumatic relay valves vent the air pressure applied to the brake actuators and the tractor and trailer brakes disengage. In the examples illustrated by FIG. 9, the relay valves can be positioned such that the pneumatic lines from the relay valves to the brake actuators are substantially the same length. For example, a difference in length between the longest pneumatic actuator line and the shortest pneumatic actuator line is less than five feet.

In modem trucks and other vehicles, an engine compartment 600 (FIG. 9) under the hood is often crowded. The temperature under the hood of vehicles has increased in recent years due to hotter running environmentally friendly engines. The disclosed hybrid air brake actuating systems allow air lines that communicate air under pressure to vehicle wheel brakes be positioned outside a vehicle engine compartment 600. In one embodiment, all air lines that communicate pressurized air to a brake actuators are positioned outside of the engine compartment. The hydraulic lines that communicate the force applied to the brake pedal to the hydraulic to pneumatic relay valves may extend through the engine compartment. The hydraulic lines are able to withstand high temperatures and take up much less space in the engine compartment than air lines. The hydraulic lines may be made of a metal tube, such as stainless steel tubing. The disclosed hybrid air brake actuating systems reduce the size of the lines used to communicate the force applied to the brake pedal and the relay valves. The disclosed air brake actuating systems reduce response time, since the response time of hydraulic fluid is faster than the response time of air. The balance of the system is improved, because the pneumatic control lines are replaced with hydraulic lines and the relay valves may be positioned such that the lines that extend from the relay valves to the brake actuators are approximately the same length. For example, the hydraulic to pneumatic relay valves can be located more centrally on a tractor in close proximity to trailer brake connectors or glad hands to improve the brake balance of the vehicle. The hydraulic to pneumatic relay valves could also be positioned such that rear brakes are applied shortly before the front brakes are applied. Modularly mounting hydraulic to pneumatic relay valves to the air supply reservoirs reduces brake response time. One application of the disclosed hydraulic to pneumatic actuating system is in rear engine vehicles, such as, rear engine busses, coaches, and specialty vehicles, such as cement mixers and construction vehicles that typically have long control and supply air brake lines.

One benefit of the disclosed hybrid air brake actuating systems is that the systems provide an improved or standardized brake pedal feel. The brake pedal feel of the hybrid air brake actuating systems would be similar to the feel of a passenger car or a light truck. The hybrid air brake actuating systems would make non-professional drivers more comfortable when driving air brake equipped rental vehicles such as moving vans, box trucks, campers, busses, etc.

While the invention has been described with reference to specific embodiments, it will be apparent to those skilled in the art that many alternatives, modifications, and variations may be made. Accordingly, the present invention is intended to embrace all such alternatives, modifications, and variations that may fall within the spirit and scope of the appended claims.

1. A hybrid air brake actuating system for controlling communication of pressurized air from an air supply to a vehicle brake, comprising:
a) a hydraulic control component that provides brake control signals through hydraulic fluid based on a position of a driver operated brake control; and
b) a hydraulic to pneumatic actuating arrangement that controls communication of pressurized air from the air supply to the vehicle brake based on the hydraulic brake control signals.

2. The hybrid air brake actuating system of claim 1 wherein the hydraulic to pneumatic actuating arrangement is a hydraulic to pneumatic relay valve.

3. The hybrid air brake actuating system of claim 1 wherein the hydraulic to pneumatic actuating arrangement comprises a hydraulic actuator assembled with a pneumatic brake valve.

4. The hybrid air brake actuating system of claim 1 wherein the hydraulic control component comprises a hydraulic master cylinder.

5. The hybrid air brake actuating system of claim 1 wherein the pressurized air is communicated to a plurality of vehicle brakes through a plurality of pneumatic lines, wherein the pneumatic lines are substantially the same length.

6. The hybrid air brake actuating system of claim 5 wherein a difference in length between the plurality of pneumatic lines is less than five feet.

7. The hybrid air brake actuating system of claim 1 wherein all conduits that communicate air under pressure to vehicle drive wheels are positioned outside a vehicle engine compartment.

8. The hybrid air brake actuating system of claim 1 wherein a first hydraulic to pneumatic actuating arrangement controls brakes of a front axle and a second hydraulic to pneumatic actuating arrangement controls brakes of a rear axle and wherein a first hydraulic fluid flow path is defined between the hydraulic control component and the first hydraulic to pneumatic actuating arrangement and a second hydraulic fluid flow path is defined between the hydraulic control component and the second hydraulic to pneumatic actuating arrangement.

9. The hybrid air brake actuating system of claim 1 wherein the hydraulic to pneumatic actuating arrangement controls application of brakes of a trailer.

10. The hybrid air brake actuating system of claim 1 wherein the hydraulic to pneumatic actuating arrangement is mounted to an air supply reservoir.

11. The hybrid air brake actuating system of claim 1 wherein the driver operated brake control compresses a brake pedal.

12. A method of controlling communication of pressurized air from an air supply to a vehicle brake, comprising:
a) providing brake control signals through hydraulic fluid based on a position of a driver operated brake control; and
b) controlling communication of pressurized air from the air supply to the vehicle brake based on the brake control signals.

13. The method of claim 12 further comprising controlling communication of air to trailer brakes based on the brake control signals.

14. The method of claim 12 wherein the driver operated brake control is a brake pedal.

15. A hydraulic to pneumatic brake relay valve for controlling communication of pressurized air from an air supply to a vehicle brake based on a hydraulic input signal, comprising:
a) a relay valve body that includes a hydraulic fluid inlet port, a pressurized air inlet port, and a brake air outlet port; and
b) a brake air regulating mechanism disposed in the valve body that controls a flow of pressurized air from the inlet port to the brake air outlet port based hydraulic pressure applied in the hydraulic fluid inlet port.

16. The hydraulic to pneumatic relay valve of claim 15 wherein the wherein the pneumatic relay valve is mounted to an air supply reservoir.

17. A hybrid air brake actuating system for controlling communication of pressurized air from an air supply to a vehicle brake, comprising:
a) a control means for providing brake control signals through a first medium based on a force applied to a driver operated brake control the brake pedal; and
b) an actuating means for controlling communication of pressurized air from the air supply to the vehicle brake based on the brake control signals.

18. The hybrid air brake actuating system of claim 17 wherein the first medium comprises hydraulic fluid.

19. The hybrid air brake actuating system of claim 17 wherein the pressurized air is communicated to a plurality of vehicle brakes through a plurality of pneumatic lines, wherein the pneumatic lines are substantially the same length.

20. The hybrid air brake actuating system of claim 19 wherein a difference in length between the plurality of pneumatic lines is less than five feet.

21. The hybrid air brake actuating system of claim 17 wherein all conduits that communicate air under pressure to vehicle wheels are positioned outside a vehicle engine compartment.

22. The hybrid air brake actuating system of claim 17 wherein the actuating means controls application of brakes of a trailer.

23. The hybrid air brake actuating system of claim 17 wherein the actuating means is mounted to an air supply reservoir.
